(19) United States
(12) Patent Application Publication
(10) Pub. No.: US 2025/0165667 A1
(43) Pub. Date: May 22, 2025

(54) GENERATOR DYNAMIC MODEL PARAMETER ESTIMATION AND TUNING USING ONLINE DATA AND SUBSPACE STATE SPACE MODEL

(71) Applicant: OPERATION TECHNOLOGY, INC., Irvine, CA (US)

(72) Inventors: Farrokh Shokooh, Laguna Beach, CA (US); Tanuj Khandelwal, Riverside, CA (US); Ahmed Yousuf Saber, Lake Forest, CA (US); J.J. Dai, Irvine, CA (US)

(21) Appl. No.: 18/825,385

(22) Filed: Sep. 5, 2024

Related U.S. Application Data
(63) Continuation of application No. 18/614,814, filed on Mar. 25, 2024.
Application No. 18/614,814 is a continuation of application No. 18/119,803, filed on Mar. 9, 2023, now abandoned.
Application No. 18/119,803 is a continuation of application No. 16/942,760, filed on Jul. 29, 2020, now abandoned.
Application No. 16/942,760 is a continuation of application No. 15/833,941, filed on Dec. 6, 2017, now abandoned.
Application No. 15/833,941 is a continuation of application No. 14/045,757, filed on Oct. 3, 2013, now Pat. No. 9,864,820.
(60) Provisional application No. 61/709,160, filed on Oct. 3, 2012.

(51) Int. Cl. G06F 30/20

(52) U.S. Cl. CPC G06F 30/20

(57) ABSTRACT

Generator dynamic model parameter estimation and tuning using online data and subspace state space models are disclosed. According to one embodiment, a system comprises a sensor, a data acquisition network in communication with the sensor, a user console and an identification and tuning engine in communication with the data acquisition network, the user console, and a database. The database comprises one or more generator models, and the identification and tuning engine identifies and tunes parameters associated with a selected generator model.

### CROSS-REFERENCE TO RELATED APPLICATIONS

The present application is a continuation of U.S. patent application Ser. No. 18/614,814, filed Mar. 25, 2024, which is a continuation of U.S. patent application Ser. No. 18/119,803, filed Mar. 9, 2023, now abandoned, which is a continuation of U.S. patent application Ser. No. 16/942,760, filed Jul. 29, 2020, now abandoned, which is a continuation of U.S. patent application Ser. No. 15/833,941, filed Dec. 6, 2017, now abandoned, which is a continuation of U.S. patent application Ser. No. 14/045,757, filed on Oct. 3, 2013, now U.S. Pat. No. 9,864,820, which claims priority to U.S. Provisional Patent Application No. 61/709,160, filed Oct. 3, 2012, the disclosures of which are incorporated by reference herein in their entireties for all purposes.

### FIELD

The embodiments relate generally to control systems, and more particularly to generator dynamic model parameter estimation and tuning using online data and subspace state space model.

### BACKGROUND

Knowledge of a rotating machine and its associated control system dynamic parameters is essential for power system transient stability simulation studies. A typical transmission power system model includes a number of frequency dependent components such as impedances, sources and loads. However, the most complex dynamic models with the largest number of variables (for example, greater than 100) to identify and tune belong to synchronous machines. What makes these parameters complex is that they are sometimes independent of each other, but they still impact the overall response of the machine to an event (such as load shedding, power system fault or large load addition into the system). Examples of such parameters include machine impedances and time constants, inertial and damping coefficients, prime mover and governor parameters, excitation system and AVR parameters, power system stabilizer (PSS) parameters, and load characteristics. Accuracy in hundreds of these parameters directly affects the credibility of the simulation results. In order to verify and validate (V&V) simulation studies, it is common to compare simulation results against field test measurements such as a generator load acceptance and rejection test. However, expertise is required to understand the effect of each parameter, as the simulation model is manually tuned to provide a similar response as that observed in field tests or recordings. The task of adjusting each variable via the trial-and-error approach is a tedious and time-consuming one. A dynamic tuned model is invaluable to a transmission planner and their regulatory agencies in order to understand the dynamic response of a system as a function of time to potential disturbances in the system.

Dynamic parameter tuning (DPT) tunes parameters of dynamic models. Given transfer function model structures (e.g., exciters, governors, power system stabilizers, generators, wind turbines, electrical machines, FACTS devices, controllers), typical values of model parameters, power system network (if available), and field recorded data using smart sensor devices like PMUs, DPT tunes parameters of dynamic model (e.g., gains, transfer functions, integrators, derivative, time constants, limiters, saturation constants, dead zones, delay) where deviation between the recorded data and the calculated output of the model using the tuned parameters is minimum. In other words, DPT can be used to estimate the values of the parameters that make the controllers respond as similar as possible to a field measured response (i.e. measurements from a staged test or field recorded disturbance). The tuning response can be accomplished by using an iterative approach that automatically adjusts the tunable settings or parameters in the model to make the controller response match that of field recorded data. This process may also be known as automatic model validation parameter tuning.

A phasor measurement unit (PMU) or synchrophasor is a device that measures the electrical waves on an electricity grid, using a common time source for synchronization. A phasor is a complex number that represents both the magnitude and phase angle of the sine waves found in electricity. Time synchronization allows synchronized real-time measurements of multiple remote measurement points on the grid. In power engineering, these are also commonly referred to as synchrophasors and are considered one of the most important measuring devices in the future of power systems. A PMU can be a dedicated device, or the PMU function can be incorporated into a protective relay or other device.

DPT is a complex constraint optimization problem in huge complex multi-dimensional search space because the above-mentioned dynamic systems are highly non-linear with limiters (saturations) and are highly sensitive to parameters; they have multiple inputs/outputs (multi-objective) and multiple solutions exist.

Particle swarm optimization (PSO) is a promising optimization method for engineering applications today. It is a swarm based iterative optimization method. Each potential solution, called a particle, flies in a multi-dimensional search space with a velocity, and the velocity is dynamically adjusted according to the flying experience of its own and other particles.

The least squares method is typically used for parameter identification (PI). Few products are available in the market for PI using mainly least square method and not a single product is available for parameter tuning (PT) where any intelligent optimization method is used.

It is very difficult and time consuming to tune the dynamic model parameters from time domain input and output values (curves or data points) because of complex relationships and high sensitivity. It is a complex constraint optimization problem in complex search space with thousands of data points including limits. Practical control systems have many complex control blocks with saturation limits (gains, transfer functions, integrators, derivative, time constants, limiters, saturation constants, dead zones, delay, etc.), and thus the traditional least square method is not suitable mainly for DPT where balance between local and global search is very important for fine tuning.

### SUMMARY

Generator dynamic model parameter estimation and tuning using online data and subspace state space models are disclosed. According to one embodiment, a system comprises a sensor, a data acquisition network in communication with the sensor, a user console and an identification and tuning engine in communication with the data acquisition network, the user console, and a database. The database comprises one or more generator models, and the identification and tuning engine identifies and tunes parameters associated with a selected generator model.

The systems, methods, features and advantages of the invention will be or will become apparent to one with skill in the art upon examination of the following figures and detailed description. It is intended that all such additional methods, features and advantages be included within this description, be within the scope of the invention, and be protected by the accompanying claims. It is also intended that the invention is not limited to require the details of the example embodiments.

### BRIEF DESCRIPTION OF THE FIGURES

The accompanying drawings, which are included as part of the present specification, illustrate the presently preferred embodiment and, together with the general description given above and the detailed description of the preferred embodiment given below, serve to explain and teach the principles of the present invention.

FIG. 1 illustrates an exemplary system level layout for use with the present system, according to one embodiment.

FIG. 2 illustrates an exemplary engine for use with the present system, according to one embodiment.

FIG. 3 illustrates an exemplary generator and PMU configuration for use with the present system, according to one embodiment.

FIG. 4 illustrates an iterative and interactive process flow for use with the present system, according to one embodiment.

FIG. 5 illustrates exemplary online event and threshold data, according to one embodiment.

FIG. 6 illustrates an exemplary data acquisition, correction, and filtering flow for use with the present system, according to one embodiment.

FIG. 7 illustrates an exemplary generator configuration with an excitation system for use with the present system, according to one embodiment.

FIG. 8 illustrates an exemplary generator model for use with the present system, according to one embodiment.

FIG. 9 illustrates an IEEE type AC8B excitation system model.

FIG. 10 illustrates an exemplary parameter tuning or estimation process for use with the present system, according to one embodiment.

FIG. 11 illustrates an exemplary configuration with multiple generators for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

Embodiments disclosed herein are directed to methods and systems for generator dynamic parameter estimation and tuning with online data by employing a subspace state space model and identification method. The present embodiments can be applied in generators, exciters, governors, power system stabilizers, wind turbines, electrical machines, FACTS devices, and controllers.

According to one embodiment, the present system enables the use of 4SID (subspace-based system identification method) to tune a combined generator model including its control system on a continuous basis, adapting as the settings or performance change overtime. The generator model includes a machine and an excitation system. Dynamic tuning is typically done by generator testing which is not possible for generation plants that are obligated to supply their scheduled power and cannot tolerate any downtime. The present embodiments therefore are preferred for systems that lack field test data and are only accessible to online measurements that are continuously fed from some local meters and a network PMU.

Dynamic parameter tuning (DPT) is a constraint optimization problem to find the best set of tuned parameter values to match with given field-measured data. An intelligent optimization method is required to come up with the optimal or near optimal values of parameters to reduce deviation between measured field data and calculated outputs. Automatic DPT adds an additional new layer in time saving capabilities, saving hundreds of engineering man-hours spent on the tedious process of model validation and parameter tuning. Parameter tuning of a power system network is very important for modeling, simulation, control and protection because it affects many power system studies, e.g., transient stability, voltage distortion, relay setting and so on. Thus, it is recommended to tune parameters over time for more accurate power system analysis results.

Applications of DPT include tuning and validating dynamic control elements of generic dynamic models. This includes but not limited to following types of controllers/dynamic models:
1) Synchronous Motors Exciter/AVR models;
2) Synchronous Generator Exciter/AVR models;
3) Synchronous Generator Turbine, Engine/Speed Control models;
4) Synchronous Generator PSS (Power System Stabilizer) models;
5) Wind Turbine Generator Models;
6) Generic Load Models (Lumped Load Element Dynamic Models).

The embodiments disclosed herein directed to DPT using MPSO can be applied in generators, exciters, governors, power system stabilizers, wind turbines, electrical machines, FACTS devices, controllers, etc. The embodiments described herein are generic, robust and they always converge. The embodiments described herein play an important role for modeling better power systems and help to simulate and build smarter grid.

The present disclosure provides advantages over prior art systems for the following reasons:
1) Dynamic parameters can heavily impact the quality of simulation results;
2) Manufacture data may not be suitable over time. Sometimes dynamic parameter values may not be available from manufactures;
3) Online field measured data is available in smart-grid;
4) Parameters are very sensitive;
5) There exists a complex input and output relation in a dynamic model; and
6) Verification and validation are not simple.

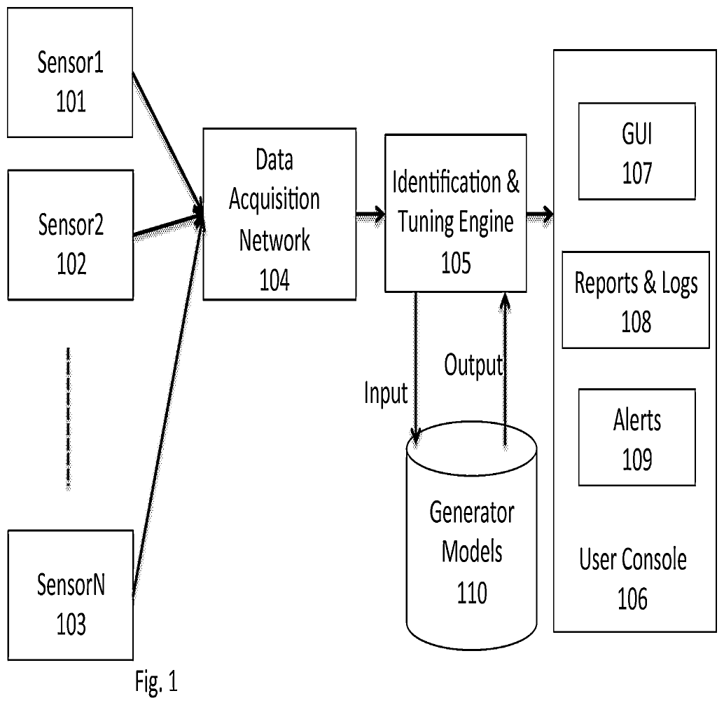

FIG. 1 illustrates an exemplary system level layout for use with the present system, according to one embodiment. According to one embodiment, a system includes a data acquisition network 104, a user console 106 that hosts a synchronous machine model including associated controls, and an identification & tuning (I&T) engine 105. The data acquisition component 104 is connected to one or more sensors (101, 102, 103) such as a PMU configured to provide real-time data and power quality waveforms from certain strategic locations in the power system. I&T engine 105 is connected to the data acquisition system 104 or the sensor(s) directly and one or more generator models 110. I&T engine 105 continuously captures events and triggers if a signal goes beyond a user-defined threshold and uses the event information to identify and/or tune the generator model 110 with parameters such that the simulated response from the generator model 110 matches actual measurements. I&T engine 105 is configured to analyze a difference between the identification and/or tuning from a previous event against a latest set of results. If the difference is significant, then the generator 110 parameters are updated making this an ongoing and continuous process. The new tuned set is logged and an alert 109 is sent to the user console 106 to retrieve and view a report 108. The report and calculation results are available to be displayed on a graphical user interface (GUI) 107. It is expected that over time, the difference between the latest and previous tuning results will reduce below the threshold such that the model has been sufficiently tuned with the help of a large number and variety of events. However, it does happen in the system that operations or maintenance make changes to the generator controllers by adjusting the dials on the generator control panel. Such a change may go unnoticed. Further, due to aging or lack of maintenance of the equipment, its performance may degrade over time. For every event therefore, the system is able to match the simulated response of the machine against the actual measurements and provide a valid machine model for power systems analysis purposes. If there are any changes made to the generator controllers, the system is able to detect the change as the latest tuned parameters will have discrepancy from the previously tuned and accepted set.

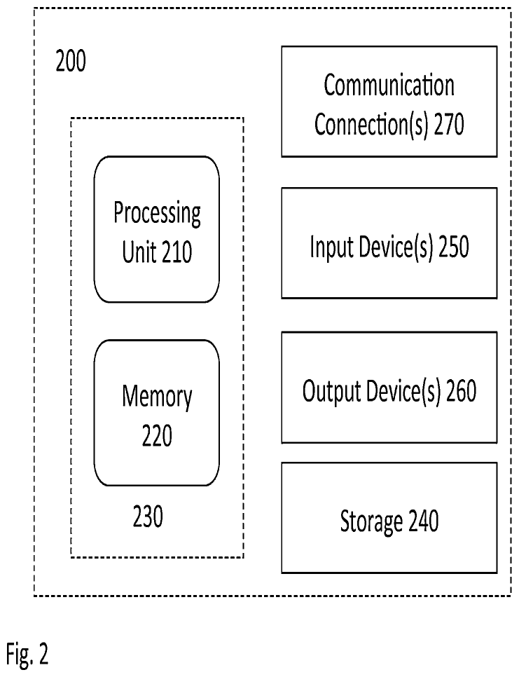

FIG. 2 illustrates an exemplary engine for use with the present system, according to one embodiment. The engine is not intended to suggest any limitation as to scope of use or functionality, as the technologies described herein may be implemented in diverse general-purpose or special purpose computing environments. With reference to FIG. 2, the engine 200 can include at least one processing unit 210 (e.g. signal processor, microprocessor, ASIC, or other control and processing logic circuitry) coupled to memory 220. The processing unit 210 executes computer-executable instructions and may be a real or a virtual processor. The memory 220 may be volatile memory (e.g. registers, cache, RAM), non-volatile memory (e.g. ROM, EEPROM, flash memory, etc.), or some combination of the two. The memory 220 can store software implementing any of the technologies described herein. The controller may have additional features. For example, the engine can include storage 240, one or more input devices 250, one or more output devices 260, and one or more communication connections 270. An interconnection mechanism (not shown), such as a bus or network interconnects the components. Typically, operating system software (not shown) provides an operating environment for other software executing in the controller and coordinates activities of the components of the engine.

The storage 240 may be removable or non-removable, and can include magnetic disks, magnetic tapes or cassettes, CD-ROMs, CD-RWs, DVDs, or any other computer-readable media that can be used to store information and which can be accessed within the controller. The storage 240 can store software containing instructions for implementing the methods and systems described herein.

The input device(s) 250 can be a touch input device such as a keyboard, mouse, pen, or trackball, a voice input device, a scanning device, or another device. The output device(s) 260 may be a display, printer, speaker, CD- or DVD-writer, or another device that provides output from the controller. Some input/output devices, such as a touchscreen, may include both input and output functionality.

The communication connection(s) 270 enables communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, microwaves, infrared, acoustic, or other carrier.

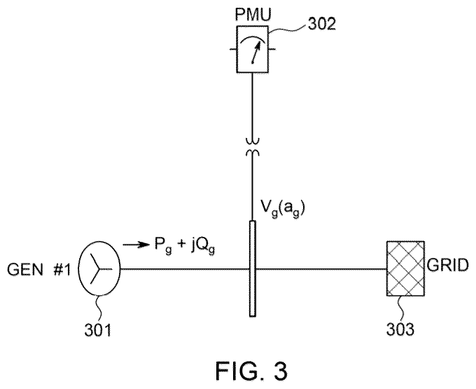

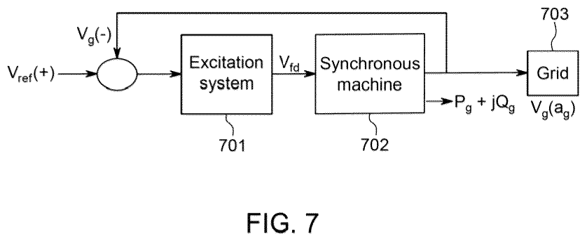

FIG. 3 illustrates an exemplary generator and PMU configuration for use with the present system, according to one embodiment. The system under consideration consists of a generator 301, a terminal PMU 302 and its measurements, and an interconnected power grid 303. It is assumed the PMU 302 measures generator 301 terminal voltage magnitude V_{g} and phase angle α_{g}, as well as generator active power P_{g} and reactive power Q_{g} generations. The generator 301 includes a synchronous machine 702, an excitation system 701, and a feedback control loop as shown in FIG. 7.

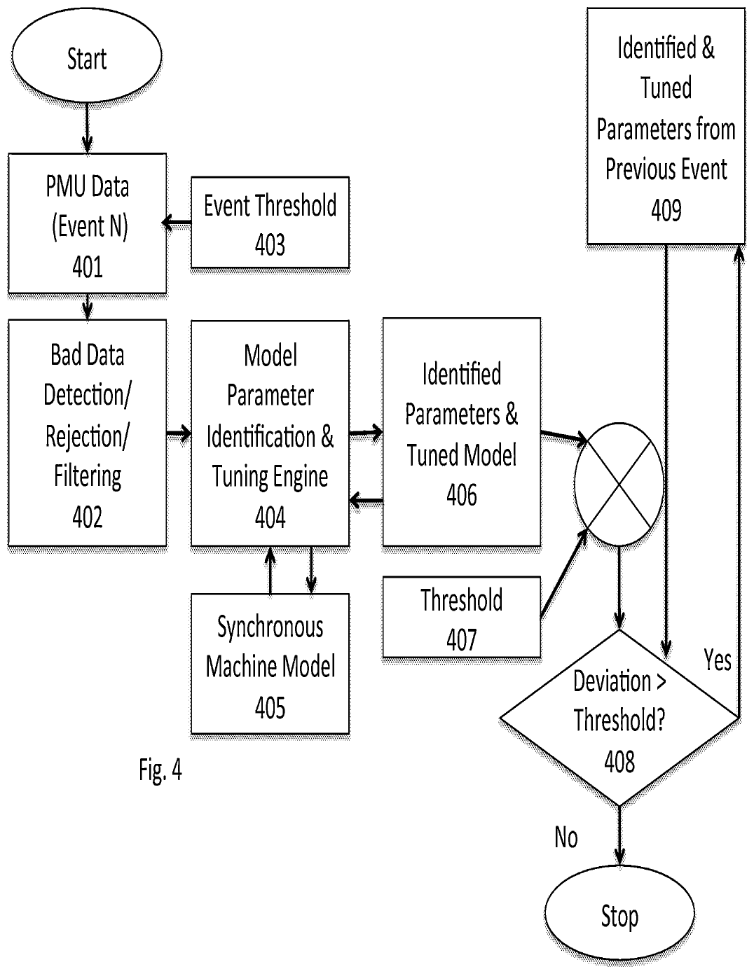

FIG. 4 illustrates a process flow for use with the present system, according to one embodiment. Synchronized data from a PMU for an event N 401, including an event threshold 403, is continuously reviewed. Bad data is detected, rejected, and/or filtered 402 before measured data is transmitted to a model parameter identification and tuning engine 404. Parameter identification and tuning is an iterative process. The model parameter identification and tuning engine 404 also receives a synchronous machine model 405 (with controls and parameters). Model and parameters for the generator are iteratively modified to minimize deviation between measured output(s) from PMUs and calculated corresponding output(s) from simulation. Deviation depends on system complexity, data availability and quality, and the optimization method applied. Optimization runs for a sufficient number of iterations so that a best model and parameters values are obtained. Identified parameters and a tuned model 406 are XOR'd (differentiated) with a deviation threshold 407. It should be noted that the event threshold is different from a deviation threshold. The output is compared to identified and tuned parameters from a previous event 409. If a deviation threshold 408 is not exceeded, the process is complete. Otherwise identified and tuned parameters from a previous event 409 are used.

A phasor measurement unit (PMU) or synchrophasor is a device that measures the electrical waves on an electricity grid, using a common time source for synchronization. A PMU can be a dedicated device, or the PMU function can be incorporated into a protective relay or other device. Using a PMU, it is simple to detect abnormal waveform shapes. A waveform shape described mathematically is called a phasor.

PMU measurements are the constraints to the dynamic model parameter estimation/tuning thus they should be enforced.

Construct a reduced order state space model:

$${\dot{x}}_{r} ( t ) = {A}_{r} ( θ ) {x}_{r} ( t ) + {B}_{r} ( θ ) {u}_{r} ( t ) \qquad ( 1 )$$

$${y}_{r} ( t ) = {C}_{r} {x}_{r} ( t ) ) \qquad ( 2 )$$

using the following conditions: Estimated generator dynamic model parameters. PMU measurements as model output yr.

Further define a sliding-mode observer from Equations (1) and (12):

$${\hat{\dot{x}}}_{r 1} ( t ) = {A}_{r 11} ( θ ) {\hat{x}}_{r 1} ( t ) + {A}_{r 11} ( θ ) {\hat{y}}_{r} ( t ) + {B}_{r 1} ( θ ) {u}_{r} ( t ) + {L}_{1} v \qquad ( 3 )$$

$${\hat{\dot{y}}}_{r} ( i ) = {A}_{r 21} ( θ ) {\hat{x}}_{r 1} ( t ) + {A}_{r 22} ( θ ) {\hat{y}}_{r} ( t ) + {B}_{r 2} ( θ ) {u}_{r} ( t ) - {L}_{2} v \qquad ( 4 )$$

$$v = sgn ( {y}_{r} - {\hat{y}}_{r} ) \qquad ( 5 )$$

Solving Equations (3), (4) and (5) using recursive least square (RLS) method by properly selecting weighting matrices L₁ and L₂, PMU measurement error v are forced to converge to zero. Thus, the updated dynamic model parameters θ have better values.

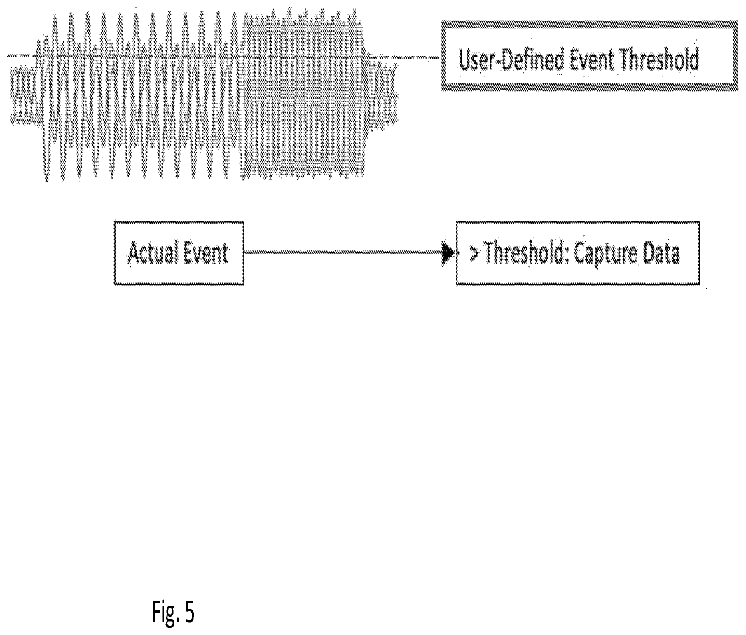

FIG. 5 illustrates exemplary online event and threshold data, according to one embodiment. The PMU data is typically collected from the system through hardware and stored in the hardware memory based on a user-defined event threshold. If the event threshold is not met, then the event is not passed on to the generator dynamic model identification and tuning system and disregarded. If the event threshold is reached, then a notification is sent to the user and the data is capture via the data acquisition network and sent to the generator dynamic model identification and tuning system.

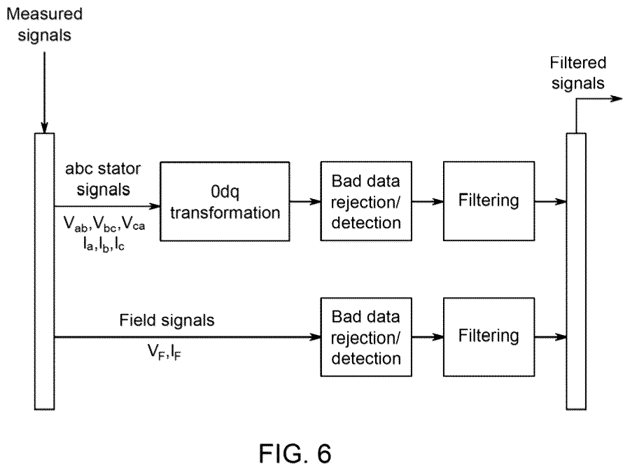

FIG. 6 illustrates an exemplary data acquisition, correction, and filtering flow for use with the present system, according to one embodiment. Real data have errors resulting mainly from meter and communication errors, incomplete metering, or inaccuracy of metering equipment. Therefore, prior to any estimation it is necessary to perform bad data detection and rejection, and filtering of the noise.

After the transformation of the abc voltages and currents into 0dq signals through Park's transformation, a filter is applied to remove noise from the measurements. Such noise appears in the form of spikes, in the time domain plot of each signal. They are caused by metering errors and can be safely removed without risking inaccuracies in the identification and tuning process. If a noise in any one signal is detected, then the whole measurement at that time is removed from the data set. Multiple filters are to be utilized in order to also remove random background noise from the measurements through utilization of butterworth or adaptive noise filters.

FIG. 7 illustrates an exemplary generator configuration with an excitation system for use with the present system, according to one embodiment. The generator includes a synchronous machine 702, an excitation system 701, and a feedback control loop Output from the generator goes to a grid 703.

### Excitation System 701 Model

State space representation of the excitation system can be written as:

$$a . {{x}^{´}}_{e} ( t ) = {A}_{e} ( {θ}_{e} ) {x}_{e} ( t ) + {B}_{e} ( {θ}_{e} ) {u}_{e} ( t ) \qquad ( 6 )$$

$$b . {y}_{e} ( t ) = {C}_{e} {x}_{e} ( t ) \qquad ( 7 )$$

where the variable sets are:

$$c . {x}_{e} = {[ \begin{matrix}{x}_{e 1} & {x}_{e 2} & ⋯ & {x}_{{en}_{e}}\end{matrix} ]}^{T} - excitation system model state variables$$

$$d . {y}_{e} = {[ \begin{matrix}{y}_{e 1} & {y}_{e 2} & ⋯ & {y}_{{em}_{e}}\end{matrix} ]}^{T} - excitation system model output variables$$

$$e . {θ}_{e} = {[ \begin{matrix}{θ}_{e 1} & {θ}_{e 2} & ⋯ & {θ}_{{ep}_{e}}\end{matrix} ]}^{T} - excitation system model parameters$$

$$f . {u}_{e} = {[ \begin{matrix}{u}_{e 1} & {u}_{e 2} & ⋯ & {u}_{{eq}_{e}}\end{matrix} ]}^{T} - excitation system model inputs$$

### Synchronous Machine 702 Model

State space representation of the synchronous machine can be written as:

$$g . {\dot{x}}_{g} ( t ) = {A}_{g} ( {θ}_{g} ) {x}_{g} ( t ) + {B}_{g} ( {θ}_{g} ) {u}_{g} ( t ) \qquad ( 8 )$$

$$h . {y}_{g} ( t ) = {C}_{g} {x}_{g} ( t ) \qquad ( 9 )$$

where the variable sets are:

$$i . {x}_{g} = {[ \begin{matrix}{x}_{g 1} & {x}_{g 2} & ⋯ & {y}_{{gn}_{g}}\end{matrix} ]}^{T} - synchronous machine model state variables$$

$$j . {y}_{g} = {[ \begin{matrix}{y}_{g 1} & {y}_{g 2} & ⋯ & {y}_{{gm}_{g}}\end{matrix} ]}^{T} - synchronous machine model output variables$$

$$k . {θ}_{g} = {[ \begin{matrix}{θ}_{g 1} & {θ}_{g 2} & ⋯ & {θ}_{{gp}_{g}}\end{matrix} ]}^{T} - synchronous machine model parameters$$

$$l . {u}_{g} = {[ \begin{matrix}{u}_{g 1} & {u}_{g 2} & ⋯ & {u}_{{gq}_{g}}\end{matrix} ]}^{T} - synchronous machine model inputs$$

### Combined Model

Combining equations (6) through (9), overall system model and state space representation become:

$$m . \dot{x} ( t ) = A ( θ ) x ( t ) + B ( θ ) u ( t ) \qquad ( 10 )$$

$$n . y ( t ) = Cx ( t ) ) \qquad ( 11 )$$

where the variable sets are:

$$o . x = {[ \begin{matrix}{x}_{1} & {x}_{2} & ⋯ & {x}_{n}\end{matrix} ]}^{T} - generator and excitation system model state variables$$

$$p . y = {[ \begin{matrix}{y}_{1} & {y}_{2} & ⋯ & {y}_{m}\end{matrix} ]}^{T} - generator and excitation system model ouput$$

$$q . θ = {[ \begin{matrix}{θ}_{1} & {θ}_{2} & ⋯ & {θ}_{p}\end{matrix} ]}^{T} - generator and excitation system model parameters$$

$$r . u = {[ \begin{matrix}{u}_{1} & {u}_{2} & ⋯ & {u}_{q}\end{matrix} ]}^{T} - generator and excitation system model inputs$$

And four coefficient matrices are:

$$s . A ( θ ) ∈ {R}^{n \times n} - system matrix$$

$$t . B ( θ ) ∈ {R}^{n \times q} - input matrix$$

$$u . C ∈ {R}^{m \times n} - output matrix$$

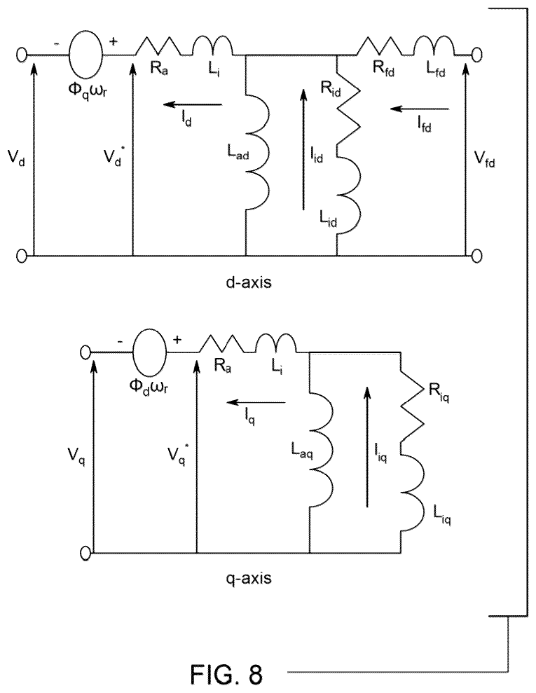

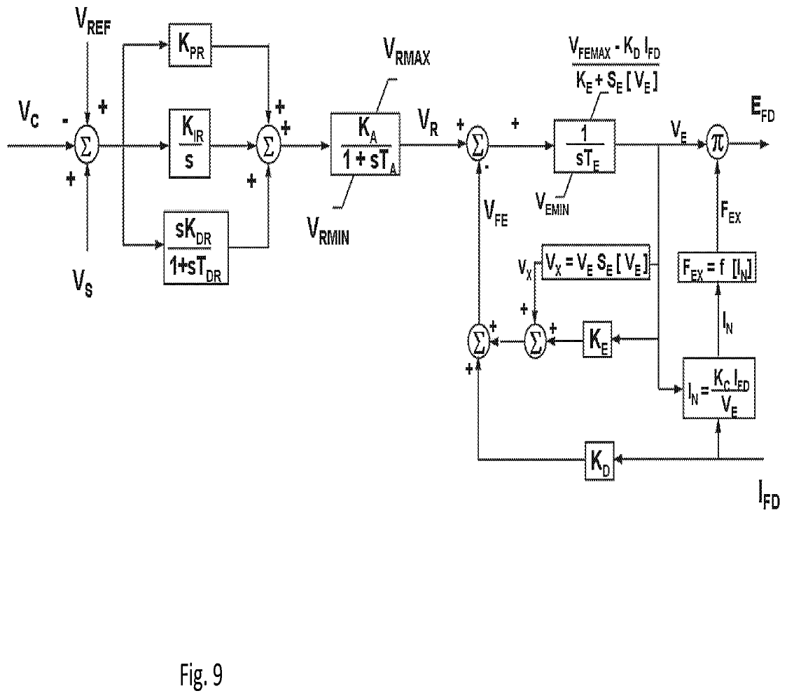

Sample synchronous machine circuit models and excitation system transfer function models are illustrated in FIGS. 8 and 9. FIG. 8 illustrates an exemplary generator model for use with the present system, according to one embodiment. FIG. 9 illustrates an IEEE type AC8B excitation system model. Since the system is operating online, it can be assumed that number of measurement data points goes to infinity and the data is ergodic. Continuously applying the identification process will track model parameters to adapt system variations. A and B are the functions of generator and exciter parameter variable set θ. These functions are in general are non-linear to θ.

During the last two decades, subspace-based system identification (4SID) methods have attracted a great deal of interest in control community and been particularly developed, because they can identify system matrices of the state space model directly from the input and output data.

Equations (10) and (11) in discrete-time form can be written as:

$$a . x ( k + 1 ) = A ( θ ) x ( k ) + B ( θ ) u ( k ) \qquad ( 12 )$$

$$b . y ( k ) = Cx ( k ) \qquad ( 13 )$$

If needed, a modified state space model can be constructed from Equations (12) and (13):

$$c . \tilde{x} ( k + 1 ) = {T}^{- 1} A ( θ ) T \tilde{x} ( k ) + {T}^{- 1} B ( θ ) u ( k ) \qquad ( 12 )$$

$$d . y ( k ) = CT \tilde{x} ( k ) \qquad ( 13 )$$

by defining a linear transformation:

$$e . \tilde{x} = {T}^{- 1} x \qquad ( 14 - 1 )$$

or

$$f . x = T \tilde{x} \qquad ( 14 - 2 )$$

where Tis in full rank.

Equations (12) and (13) can be re-written into:

$$g . \tilde{x} ( k + 1 ) = \hat{A} ( θ ) ( k ) + \hat{B} ( θ ) u ( k ) \qquad ( 15 )$$

$$h . y ( k ) = \hat{C} \tilde{x} ( k ) \qquad ( 16 )$$

Base conversion matrix T is chosen take the advantages of following facts, if applicable:

Make system matrix Â(θ) and input matrix \hat{B}(θ) simpler or more linear with respect to parameter set θ.

Time constants represented by Â(θ) are larger than those by A(θ).

The objective is to identify system matrix Â(θ) and output matrix \hat{B} (θ) in Equation (10) and from which solve for model parameter θ.

Subspace state space model identification (4SID) method allows to estimate model matrices Â, \hat{B} and Ĉ from N+α−1 points of data set of input and output measurements:

$$i . {Y}_{k} = \{ y ( k ) y ( k + 1 ) ⋯ y ( N + α - 1 \} \qquad ( 17 - 1 )$$

$$j . {U}_{k} = \{ u ( k ) u ( k + 1 ) ⋯ u ( N + α - 1 \} \qquad ( 17 - 2 )$$

Construct the following input-output equation derived in Equation (15):

$$k . {Y}_{α} = {Γ}_{α} {\tilde{X}}_{N} + {H}_{α} {U}_{α} \qquad ( 18 )$$

$$where$$

$$l . {\tilde{X}}_{N} = [ \begin{matrix}{\tilde{x}}_{} ( 1 ) & {\tilde{x}}_{} ( k + 2 ) & ⋯ & {\tilde{x}}_{} ( k + N )\end{matrix} ] - state sequence matrix$$

$$m . {Y}_{α} = [ \begin{matrix}{y}_{1} & {y}_{2} & ⋯ & {y}_{N} \\ {y}_{2} & {y}_{3} & ⋯ & {y}_{N + 1} \\ ⋮ & ⋮ & ⋱ & ⋮ \\ {y}_{α} & {y}_{α + 1} & ⋯ & {y}_{N + α - 1}\end{matrix} ] - output block Hankel matrix$$

$$n . {Γ}_{α} = [ \begin{matrix}\hat{C} \\ \hat{C} \hat{A} \\ ⋮ \\ \hat{C} {\hat{A}}^{α - 1}\end{matrix} ] - extended observability matrix$$

Equation (17) can solved by 4SID method and matrices Â(θ), \hat{B}(θ) and Ĉ are extracted from Γ_{α} and \tilde{X}_{N}. Model parameter θ can be finally evaluated.

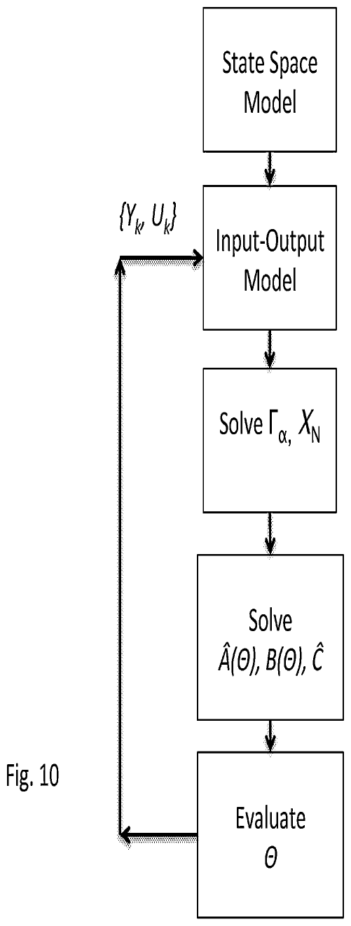

FIG. 10 illustrates an exemplary parameter tuning or estimation process for use with the present system, according to one embodiment. In the process, online measurements {Yₖ, Uₖ} feed the calculation engine as if there is a rolling data window with a selected number of data points. At the end of each calculation cycle, model parameters θ are computed and updated.

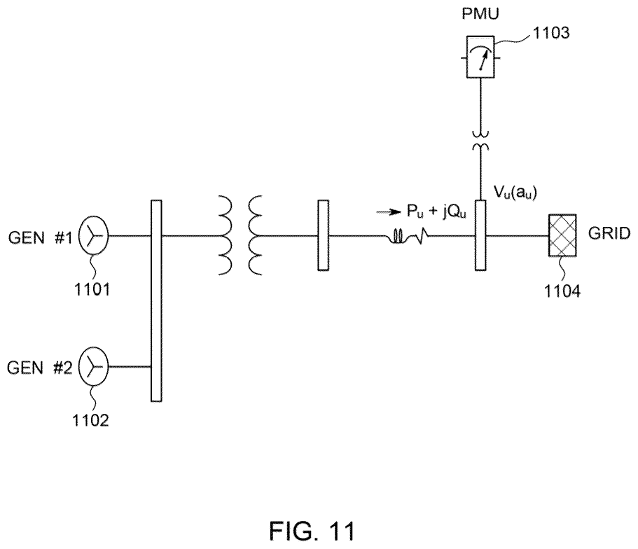

FIG. 11 illustrates an exemplary configuration with multiple generators for use with the present system, according to one embodiment. The described algorithm can be extended to a more general system configuration with multiple generators 1101, 1102 in the system whose dynamic parameters are to be identified, a PMU 1103 located at a remote bus and a section of transmission system in between generators and the grid 1104. In this case, network state variables, i.e. bus voltage magnitudes and angles, are included in the overall equations.

Disclosures of the following references are considered relevant to the present disclosure and are hereby incorporated by reference in their entirety.
L. Ljung, System Identification—Theory for the User, 2nd ed. Englewood Cliffs, N.J.: Prentice-Hall, 1999.
V. I. Utkin, J. G. Gulner, and J. Shi, Sliding Mode Control in Electromechanical Systems. New York: Taylor & Francis, 1999.
Chin-Chu Tsai, Wei-Jen Lee, Eithar Nashawati, Chin-Chung Wu, Hong-Wei Lan, “PMU Based Generator Parameter Identification to Improve the System Planning and Operation”, 2012 IEEE PES GM, San Diego, August 2012, paper No. GM0822.
E. P. T. Cari, L. F. C. Alberto, “Parameter Estimation of Synchronous Generators from Different Types of Disturbances”, 2011 IEEE PES GM, July 2011, Detroit, Mich., paper No. 10.1109/PES.2011.6039592.
E. P. T. Cari, L. F. C. Alberto, N. G. Bretas, “A New Methodology for Parameter Estimation of Synchronous Generator from Disturbance Measurements”, IEEE PES GM, Pittsburgh, Pa., July 2008, paper No. 10.1109/PES.2008.4596407.
H. Bora Karayaka, Ali Keyhani, Gerald Thomas Heydt, Baj L. Agrawal, “Synchronous Generator Model Identification and Parameter Estimation From Operating Data”, IEEE Transactions on Energy Conversion, Vol., 18, No. 1, March 2003, pp. 121-126.
Jin-Cheng Wang, Hsiao-Dong Chiang, Chiang-Tsung Huang, Yuang-Tung Chen, Chung-Liang Chang, Chiung-Yi Huang, “Identification of Excitation System Models Based on On-line Digital Measurements”, IEEE Transactions on Power Systems, Vol. 10, No. 3, August 1995, pp. 1286-1293.
H. Tsai, A. Keyhani, J. Demcko, R. G. Farmer, “On-Line Synchronous Machine Parameter Estimation from Small Disturbance Operating Data”, IEEE Transactions on Energy Conversion, Vol. 10, No. 1, March 1995, pp. 25-36.
Adel A. Ghandakly, Jiang J. Dai, “An Adaptive Synchronous Generator Stabilizer Design by Generalized Multivariable Pole Shifting (GMPS) Technique”, IEEE Transactions on Power Systems, Vol. 7, No. 3, August 1992, pp. 1239-1244.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

Systems and methods for dynamic parameter estimation and tuning have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

What is claimed is:

1. A system, comprising:
a sensor;
a data acquisition network in communication with the sensor;
a user console; and
an identification and tuning engine in communication with the data acquisition network, the user console, and a database, the database comprising one or more generator models;
wherein the identification and tuning engine identifies and tunes parameters associated with a selected generator model.

2. The system of claim 1, wherein the tuning engine identifies and tunes parameters by:
measuring current event data using the sensor;
upon detecting the current event data comprises bad data, one of rejecting or filtering the bad data;
receiving a machine model including model controls;
identifying and tuning model parameters based on the current event data and the machine model;
comparing the identified and tuned model parameters associated with the current event to a predefined threshold; and
selecting one of the identified and tuned model parameters associated with the current event or identified and tuned parameters associated with a previous event based on the comparing.

3. The system of claim 1, wherein the sensor is a PMU.

4. The system of claim 1, further comprising a plurality of sensors.

5. The system of claim 1, wherein the user console comprises a graphic user interface, and generates one or more of a report, a log, and an alert based on received parameters.

6. The system of claim 2, wherein the detecting of bad data and one of rejecting or filtering the bad data comprises:
receiving signals of the current event data, the signals comprising abc signals and field signals;
transforming the abc signals into 0dq signals by using Park's transformation;
filtering the 0dq signals and the field signals to remove noise from the current event data, wherein a measurement associated with a signal having noise is removed from the current event data.

7. The system of claim 6, wherein the filtering is performed by using one or more of butterworth and adaptive noise filters.

8. A method of identifying and tuning model parameters, comprising:
measuring current event data using a sensor;
upon detecting the current event data comprises bad data, one of rejecting or filtering the bad data;
receiving a machine model including model controls;
identifying and tuning model parameters based on the current event data and the machine model;
comparing the identified and tuned model parameters associated with the current event to a predefined threshold; and
selecting one of the identified and tuned model parameters associated with the current event or identified and tuned parameters associated with a previous event based on the comparing.

9. The method of claim 8, wherein the sensor is a PMU.

10. The method of claim 1, wherein current event data is measured by using a plurality of sensors.

11. The method of claim 8, wherein a user console comprising a graphic user interface generates one or more of a report, a log, and an alert based on received parameters.

12. The method of claim 8, wherein the detecting of bad data and one of rejecting or filtering the bad data comprises:
receiving signals of the current event data, the signals comprising abc signals and field signals;
transforming the abc signals into 0dq signals by using Park's transformation; and
filtering the 0dq signals and the field signals to remove noise from the current event data, wherein a measurement associated with a signal having noise is removed from the current event data.

13. The system of claim 12, wherein the filtering is performed by using one or more of butterworth and adaptive noise filters.
